(19) United States
(12) Patent Application Publication
(10) Pub. No.: US 2025/0244034 A1
(43) Pub. Date: Jul. 31, 2025

(54) A SYSTEM FOR CONTROLLING CHILLED WATER PLANT

(71) Applicant: EXERGENICS PTY LTD, Melboume, Victoria (AU)

(72) Inventors: Iain William STEWART, Melbourne (AU); Timothy Angus STEWART, Melbourne (AU); Richard Oliver PHILLIPS, Melbourne (AU); John CHRISTIAN, Melbourne (AU); Kevin ENRIQUEZ, Melbourne (AU); Nobel WONG, Melbourne (AU); Yi-Jen LIN, Melbourne (AU)

(73) Assignee: EXERGENICS PTY LTD, Melbourne (AU)

(21) Appl. No.: 18/853,941

(22) PCT Filed: Apr. 4, 2023
(86) PCT No.: PCT/AU2023/050262

§ 371 Date: Oct. 3, 2024

(30) Foreign Application Priority Data
Jul. 4, 2022 (AU) 2022900909

(51) Int. Cl. F24F 11/46; F24F 11/63; F28F 27/00

(52) U.S. Cl. CPC F24F 11/46; F24F 11/63; F28F 27/003

(57) ABSTRACT

Disclosed herein is a system for controlling a chilled water plant comprising one or more chillers, one or more water pumps, and a controller. The system comprise one or more processors configured to receive information comprising historical data for a plurality of system variables for the chilled water plant; determine historical performance information for the chilled water plant; prepare performance models comprising: at least one chiller predictive model; and at least one pump predictive model; prepare a field load predictive model for a field load demand; prepare a chilled water plant model; simulate operation of the chilled water plant and determining first optimised control parameters for the chilled water plant; determine an energy consumption of the chilled water plant; determine optimised control parameters for the chilled water plant; and output the optimised control parameters to the controller of the chilled water plant to optimise control of the chilled water plant.

### TECHNICAL FIELD

The present disclosure relates to a system for controlling chilled water plant. In particular, the present disclosure relates to a model predictive control (MPC) based optimisation system for determining the optimal operating points of chilled water plant equipment, and thereby enabling more optimal performance of the equipment (e.g. minimising energy consumption and improving performance).

### BACKGROUND ART

Chilled water plants form part of heating, ventilation, and air conditioning (HVAC) systems, and are present in many buildings, including commercial office buildings, shopping centres, residential, data centres, hospitals, hotels and industrial buildings. Chilled water plants comprise many pieces of equipment, including chillers, pumps, and cooling towers. Typically, chilled water plants provide chilled water to the building, which in turn provides cooling to the indoor environment via air which transfers heat to the cooled water. Heat from the building is transferred across the chiller, pumped via condenser water to the cooling tower, and rejected from the building through the cooling tower.

Chilled water plants are significant energy users in any building (up to 40% of energy consumption), and as such optimisation of their operation provides significant benefit. The efficiency of a chiller (or chilled water plant) is measured in terms of its Coefficient of Performance (COP). This reflects the ratio of kW of cooling delivered (kWr) to kW of electrical energy (kWe) consumed.

The overall efficiency of a chilled water plant is influenced by the efficiency of the individual components of the plant, including chillers, cooling towers, water pumps, motors. The performance of these components can directly affect the efficiency of other components of the plant. This interdependence leads to challenges in selecting optimal control strategies.

Typical chilled water plants are controlled using first-principles methods or ‘rules of thumb’, though in cases some degree of optimisation through ongoing tuning is achieved. Control strategies are typically input manually into a building management system (BMS).

Modelling of a chilled water plant is technically complex, and involves accurately describing the various components of the plant and their interactions. Current methods for control of chiller staging and load balancing are ‘ad hoc’, simple, and often imprecise. Condenser water temperature reset strategies typically involve a simple ‘rule of thumb’ algorithm such as wet bulb temperature+4° C. The technical problem associated with the use of ‘rule of thumb’ when selecting operating points is that the system components, and system as a whole, operate inefficiently, which results in wasted energy. Further, the equipment may start and stop unnecessarily, thereby reducing the service life of the equipment.

Optimisation of such plants/control systems is computationally complex, and finding a globally optimal solution may be infeasible using typical optimisation approaches, especially considering the number of variables involved. Standard practice is for engineers to use their own experience through trial and error to incrementally improve the efficiency of individual pieces of equipment. This may be imprecise and is an unreliable method for whole system improvement. While the use of this method may provide a better solution than simply using ‘rule of thumb’ set and forget operating points, similar technical problems remain.

Computer based optimisation of these plants focuses on using real time data, which can be costly to implement and technically difficult to maintain. This type of real time onsite optimisation is referred to as “black-box” optimisation, and presents a number of commercial and technical problems. For example, there is significant upfront cost to the user associated with installation and setup of onsite equipment that must be interfaced with the existing BMS. A facility manager will also lose some element of control and oversight of the system, as the black box operation is typically opaque. These systems may impede a technician's ability to interrogate system issues and may prevent visibility of controls.

In this specification, unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### SUMMARY

Disclosed herein is a system for controlling chilled water plant. The chilled water plant may comprise one or more chillers, one or more water pumps, and a controller. The system may comprise one or more processors configured to receive first information, the first information comprising historical data for a plurality of system variables for the chilled water plant; determine historical performance information for the chilled water plant using the received first information; prepare performance models using the received first information and historical performance information, the performance models comprising: at least one chiller predictive model for the one or more chillers; and at least one pump predictive model for the one or more water pumps; prepare a field load predictive model for a field load demand; prepare a chilled water plant model that is dependent on the at least one chiller predictive model and the at least one pump predictive model; simulate operation of the chilled water plant for a plurality of plant operating conditions using the chilled water plant model and determining first optimised control parameters for the chilled water plant; determine an energy consumption of the chilled water plant using the first optimised control parameters for a plurality of load demands to determine an optimised control strategy for the one or more chillers; determine second optimised control parameters for the chilled water plant using the energy consumption of the chilled water plant, the optimised control strategy for the one or more chillers and the field load predictive model; and output the second optimised control parameters for the chilled water plant to the controller of the chilled water plant to optimise control of the chilled water plant.

In some forms, the chilled water plant comprises one or more cooling towers, the performance models further comprises at least one cooling tower predictive model for the one or more cooling towers, and preparing the chilled water plant model is dependent on the at least one cooling tower predictive model.

In some forms, the one or more processors are configured to verify the historical performance information by preparing energy balance information for the chilled water plant using at least the first information, the energy balance information comprising a chiller energy balance for the one or more chillers, and a cooling tower energy balance for the one or more cooling towers.

In some forms, the first information comprises a plurality of timestamped chiller cooling loads, chiller energy consumptions, ambient air conditions, chiller lifts or condenser water leaving temperatures and chilled water leaving temperatures, cooling tower fan variable speed drive speeds, chilled and/or condensing water pump speeds or flow rates, and differential pressures across a chiller condenser and a chiller evaporator.

In some forms, the first information comprises supplementary metadata, the supplementary metadata comprising a chiller nominal cooling capacity, a minimum and a maximum flow rate through a condenser and an evaporator that forms part of the chilled water plant, rated energy consumption for fans and pumps that form part of the chilled water plant.

In some forms, the one or more processors are configured to transform the first information to determine second information, the second information comprising chiller lift and chiller load, wherein the determined second information then forms part of the first information that is used to prepare the performance models.

In some forms, preparation of the at least one chiller predictive model comprises developing and training a machine learning based predictive mathematical model for the one or more chillers.

In some forms, preparation of the field load predictive model comprises developing and training a machine learning based predictive mathematical model for field load.

In some forms, preparation of the at least one pump predictive model comprises developing and training a machine learning based predictive mathematical model for the for the one or more water pumps.

In some forms, preparation of the at least one cooling tower predictive model comprises developing and training a machine learning based predictive mathematical model for the one or more cooling towers.

In some forms, determining the optimised control strategy for the one or more chillers comprises; determining a total electric power consumed by the chilled water plant at a plurality of field demands to determine the optimised control strategy, the optimised control strategy comprising chiller staging setpoints, chiller load balancing proportions, condenser water entering temperature, and condenser water pump speeds at the plurality of field demands.

In some forms, determining the optimised control strategy for the one or more chillers comprises constraining the determination of the optimised control strategy by including a minimum and a maximum lift for the one or more chillers, a minimum and a maximum entering and/or leaving condenser water temperature for the one or more chillers, a minimum and a maximum entering and/or leaving evaporator water temperature for the one or more chillers, a minimum and a maximum flow rate through one or more evaporators of the one or more chillers, a minimum and a maximum flow rate through one or more condensers of the one or more chillers, a turn down ratio for the one or more chillers, a turn down ratio for the one or more cooling towers, a maximum amps for the one or more chillers, and a maximum stage up demand setpoint for the one or more stages of possible chiller operation.

In some forms, determining the second optimised control parameters for the chilled water plant comprises preparing a cost function of a plurality of system variables, the plurality of system variables comprising an energy consumption, a peak demand, a chiller loading, an aggregated number of chiller start/stop cycles, a chiller runtime, an aggregated number of chiller short cycles within a predetermined period, and a weighted runtime balance between the one or more chillers.

In some forms, preparing the cost function comprises applying a weighting for each one of the plurality of system performance variables.

In some forms, the second optimised control parameters comprise chiller stage up/down demand setpoints, chiller load balancing proportions, condenser water leaving temp setpoints; and/or condenser water flow setpoints.

Also disclosed herein is a method for optimising the control of chilled water plant. The chilled water plant may comprise one or more chillers, one or more water pumps, and a controller. The method may comprise: receiving at one or more processors a first information, the first information comprising historical data for a plurality of system variables for the chilled water plant; determining historical performance information for the chilled water plant using the one or more processers, determination of the historical performance information for the chilled water plant being dependent on the received first information; preparing performance models using the one or more processers, preparation of the performance models being dependent on the received first information and historical performance information, the performance models comprising: at least one chiller predictive model for the one or more chillers, and at least one pump predictive model for the one or more water pumps; preparing a field load predictive model for a field load demand using the one or more processers; preparing a chilled water plant model using the one or more processers, preparation of the chilled water plant model being dependent on the at least one chiller predictive model, the at least one cooling tower predictive model and the least one pump predictive model; simulating operation of the chilled water plant for a plurality of plant operating conditions using the one or more processers to determine first optimised control parameters for the chilled water plant, simulation of the operation of the chilled water plant being dependent on the chilled water plant model; determining an energy consumption of the chilled water plant using the one or more processers to determine an optimised control strategy for the one or more chillers, determining the energy consumption of the chilled water plant being dependent on the first optimised control parameters for a plurality of load demands; determining second optimised control parameters for the chilled water plant using the one or more processors, determination of the second optimised control parameters being dependent on the energy consumption of the chilled water plant, the optimised control strategy for the one or more chillers and the field load predictive model; and outputting the second optimised control parameters for the chilled water plant to the controller of the chilled water plant to optimise control of the chilled water plant.

In some forms, the chilled water plant comprises one or more cooling towers, and wherein the performance models further comprises at least one cooling tower predictive model for the one or more cooling towers, and preparing the chilled water plant model is dependent on the at least one cooling tower predictive model.

In some forms, verifying the historical performance information by preparing an energy balance information for the chilled water plant using the one or more processors, the preparation of the energy balance information being dependent on at least the first information, the energy balance information comprising a chiller energy balance for the one or more chillers, and a cooling tower energy balance for the one or more cooling towers.

In some forms, the first information comprises a plurality of timestamped chiller cooling loads, chiller energy consumptions, ambient air conditions, chiller lifts or condenser water leaving temperatures and chilled water leaving temperatures, cooling tower fan variable speed drive speeds, chilled and/or condensing water pump speeds or flow rates, and differential pressures across a chiller condenser and a chiller evaporator.

In some forms, the first information comprises supplementary metadata, the supplementary metadata comprising a chiller nominal cooling capacity, a minimum and a maximum flow rate through a condenser and an evaporator that forms part of the chilled water plant, rated energy consumption for fans and pumps that form part of the chilled water plant.

In some forms, the method further comprises transforming the first information using the one or more processors to determine second information, the second information comprising chiller lift and chiller load, wherein the determined second information then forms part of the first information that is used to prepare the performance models.

In some forms, preparation of the at least one chiller predictive model comprises developing and training a machine learning based predictive mathematical model for the one or more chillers using the more or more processors; preparation of the field load predictive model comprises developing and training a machine learning based predictive mathematical model for field load using the more or more processors; preparation of the at least one pump predictive model comprises developing and training a machine learning based predictive mathematical model for the one or more water pumps; and preparation of the at least one cooling tower predictive model comprises developing and training a machine learning based predictive mathematical model for the one or more cooling towers. For plant that does not include a cooling tower, no predictive model is developed, trained and utilised for the cooling tower.

In some forms, determining the optimised control strategy for the one or more chillers comprises determining a total electric power consumed by the chilled water plant at a plurality of field demands to determine the optimised control strategy, the optimised control strategy comprising chiller staging setpoints, chiller load balancing proportions, condenser water entering temperature, and condenser water pump speeds at the plurality of field demands.

In some forms, determining the optimised control strategy for the one or more chillers comprises constraining the determination of the optimised control strategy by including a minimum and a maximum lift for the one or more chillers, a minimum and a maximum entering and/or leaving condenser water temperature for the one or more chillers, a minimum and a maximum entering and/or leaving evaporator water temperature for the one or more chillers, a minimum and a maximum flow rate through one or more evaporators of the one or more chillers, a minimum and a maximum flow rate through one or more condensers of the one or more chillers, a turn down ratio the one or more chillers, a turn down ratio for the one or more cooling towers, a maximum amps for the one or more chillers, and a maximum demand setpoint for the one or more stages of chiller operation.

In some forms, determining the second optimised control parameters for the chilled water plant comprises preparing a cost function of a plurality of system variables, the plurality of system variables comprising an energy consumption, a peak demand, a chiller loading, an aggregated number of chiller start/stop cycles, a chiller runtime, an aggregated number of chiller short cycles within a predetermined period, and a weighted runtime balance between the one or more chillers.

In some forms, preparing the cost function comprises applying a weighting for each one of the plurality of system variables.

In some forms, the second optimised control parameters comprise chiller stage up/down demand setpoints, chiller load balancing proportions, condenser water leaving temp setpoints; and/or condenser water flow setpoints.

### BRIEF DESCRIPTION OF DRAWINGS

Various embodiments/aspects of the disclosure will now be described with reference to the following figures.

FIG. 1 provides a block diagram for a method of optimising and controlling chilled water plant according to the present disclosure;

FIG. 2 provides a flow diagram for a method of optimising and controlling chilled water plant according to the present disclosure;

FIG. 3 provides another flow diagram for a method of optimising and controlling chilled water plant according to the present disclosure;

FIG. 4 provides a flow diagram for the API ingestion of data, and automated data transformation steps shown in FIG. 3;

FIG. 5 provides a flow diagram of the modelling and two stage optimisation processes shown in FIG. 3;

FIG. 6 provides a flow diagram of the delivery of the optimised chilled plant strategy to a chilled water plant controller shown in FIG. 3;

FIG. 7 provides a flow diagram of the stage 1 optimisation process shown in FIG. 3; and

FIG. 8 provides a flow diagram of the stage 2 optimisation process shown in FIG. 3.

### DETAILED DESCRIPTION

This present disclosure provides a system and method for developing and deploying a set of optimised control points for chilled water plant equipment, that improve the efficiency and performance of the plant, without impacting service delivery. The system and method may employ strategies including predictive ML algorithms on historical data to model the plant equipment and their interactions, alongside efficient global optimisation methods.

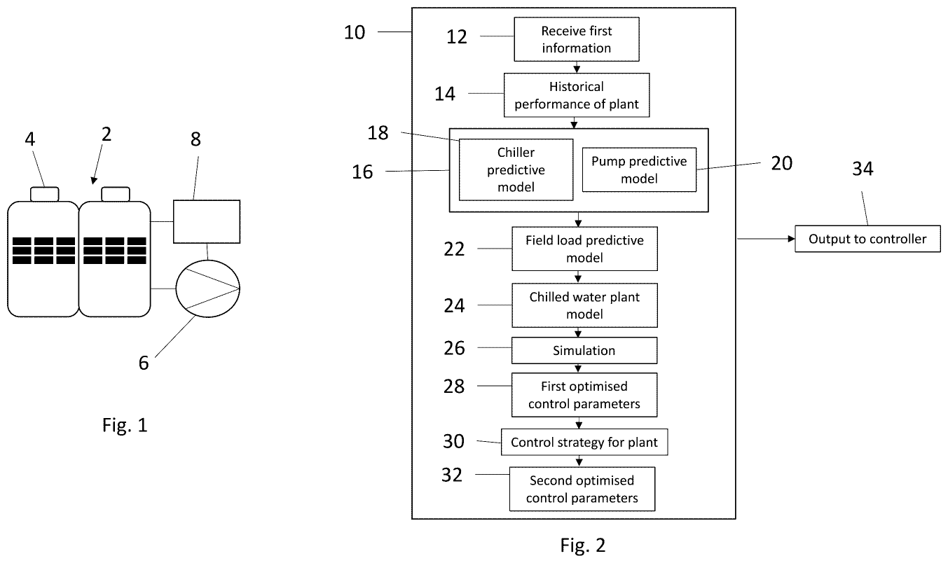

Referring to FIG. 1, the present disclosure provides a system for controlling chilled water plant 2, wherein the chilled water plant 2 comprises a chiller 4, a water pump 6 and a controller 8. Referring to FIG. 2, the system comprises a processor 10 that is configured to: (i) receive first information 12, the first information comprising historical data for a plurality of system variables for the chilled water plant; (ii) determine historical performance information for the chilled water plant 14 using the received first information; (iii) prepare performance models using the received first information and historical performance information 16, the performance models comprising: (a) at least one chiller predictive model for the chiller 18; and (b) at least one pump predictive model for the water pump 20; (iv) prepare a field load predictive model for a field load demand 22; (v) prepare a chilled water plant model that is dependent on the at least one chiller predictive model and the at least one pump predictive model 24; (vi) simulate operation of the chilled water plant 26 for a plurality of plant operating conditions using the chilled water plant model and determining first optimised control parameters for the chilled water plant 28; (vii) determine an energy consumption of the chilled water plant using the first optimised control parameters for a plurality of load demands to determine an optimised control strategy for the chiller 30; (viii) determine second optimised control parameters for the chilled water plant 32 using the energy consumption of the chilled water plant, the optimised control strategy for the chiller and the field load predictive model; and (ix) output the second optimised control parameters for the chilled water plant to the controller of the chilled water plant to optimise control of the chilled water plant.

More particularly, the present disclosure provides optimised control strategies for a chilled water plant that may include:
one or more chillers of the same or differing capacities and make/model;
one or more cooling towers (open or closed circuit) (unless air-cooled or ocean-cooled);
one or more chilled water pumps; and
one or more condenser water pumps (unless air cooled).

In the detailed embodiment hereinafter described, the chilled water plant includes the above referenced one or more cooling towers. However, as the skilled addressee would recognise, in other embodiments (not described in detail), the chilled water plant may not include cooling towers (e.g. air cooled, ocean/water body cooled, etc). With appropriate modifications, the process described below is able to be simply adapted for this type of chilled water plant.

The system and method disclosed is able to assess chillers and pumps coupled to one or more chilled and condenser water headers.

While less data can also be used to provide a useful output, the Applicant has determined that the use of one year or more of historical telemetry data to develop a model of the chilled water plant and its interactions, as well as wider system and building dynamics, and a number of global optimisation algorithms in parallel and series provides for the ability to effectively determine these operating points and control strategies.

Historical performance data for the chilled water plant may be extracted from a BMS, analytics platform, data lake, or independent data layer that has been implemented for the plant. These data may be extracted via an API and includes a plurality of system variables, including for example:
temperatures;
pressures;
flow rates;
energy consumption;
setpoints; and
ambient conditions (eg wet bulb temperature, dry bulb temperature, relative humidity, building occupancy, time of day, day of week, etc).

The historical performance data are in the form of a time series, representing the operating conditions of the various pieces of plant equipment over time.

Digital predictive models of the chilled water plant are developed, which include models of various individual plant equipment and their interactions and a predictive model of field load demand. These models are developed using ML applied to the historical performance data sets, in order to simulate the energy consumption of the plant under different operating conditions.

This mathematical plant model is used to evaluate the objective function of an optimisation algorithm (with the objective function to be minimised being the energy consumption of the entire plant). The optimisation process results in the production of an initial set of optimised control parameters for the chilled water plant. These control parameters are subsequently used to determine energy consumption data and an optimised chiller control strategy. Optimal control points are computed for all operating conditions using the foregoing information. To further optimise the plant, a secondary optimisation process is conducted under additional constraints to produce an optimised control strategy that comprises further/refined optimised control points for the whole plant. The new objective and outcome of the secondary optimisation process is a weighted function incorporating the energy consumption data, peak demand, field load predictive model, optimised chiller control strategy and statistics related to mechanical performance (chiller runtime, chiller loading, chiller start/stop count, chiller short cycle count). The secondary optimisation incorporates hysteresis. The optimised strategy includes, but may not be limited to:
chiller staging setpoints;
chiller load balancing setpoints;
condenser water entering temperature setpoints; and
condenser water flow rates.

Once the optimised control strategy is developed, the control points can be made available to the controller of the chilled water plant via a Restful API allowing the BMS (or any other middleware) to either fetch (pull) or receive (push) the required data in structured format. The user is able to interrogate simulated results before any setpoints are deployed via an online portal. These control points are then incorporated into the existing BMS.

Machine learning data driven optimisation can be conducted at relatively low cost, when compared with black-box, onsite, or real time optimisation strategies, especially considering no additional hardware is required. The existing BMS infrastructure remains unmodified, and the incumbent provider retains transparency over their system and controls.

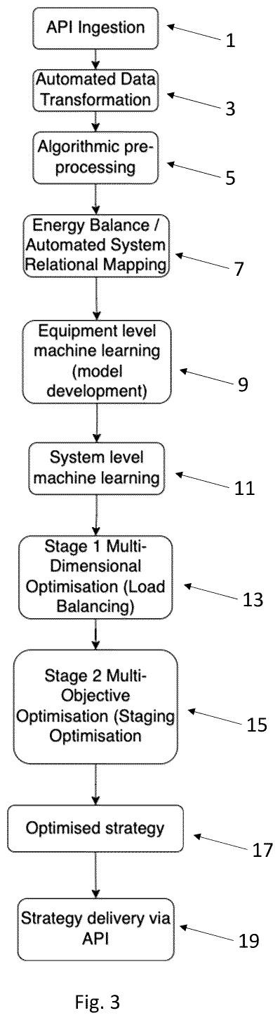

The system and method of optimising and controlling the chilled water plant will now be described with reference to FIGS. 3-8.

FIG. 3 provides a flow diagram for the method of optimising and controlling chilled water plant. At a macro level, the process involves the following sequential steps, each of which are performed by one or more processors of a computer system; API ingestion of data 1, automated data transformation 3, data pre-processing 5, optional energy balancing 7 to verify the data pre-processing steps, the preparation of models for each component of the chilled water plant 9, system level machine learning 11 using the models for each component of the chilled water plant, two stage optimisation of the chilled water plant 13, 15 to determine an optimised control strategy for the chilled water plant 17, and an output of optimised strategy to the controller of the chilled water plant 19.

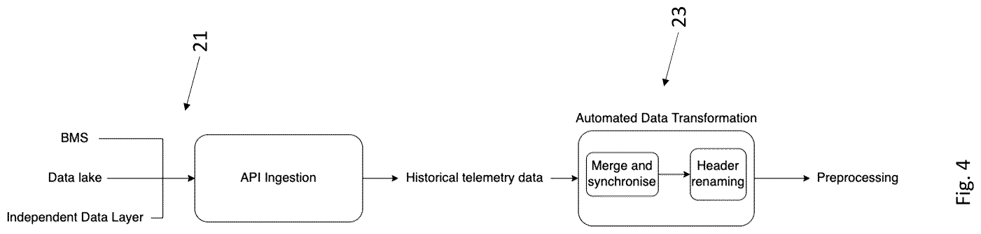

FIG. 4 provides a flow diagram for the API ingestion of data, and automated data transformation steps referenced above and in FIG. 3. The process initially involves data collection and data pre-processing/normalisation. This includes collecting or extracting 21 historical telemetry data from the relevant BMS, analytics platform, data lake, or independent data layer via an API. For a chilled water plant that includes a chiller and cooling tower, the following historical performance data may be received via the API:
Timestamp
Chiller cooling load (kWr)
Chiller energy consumption (kWe)
Ambient air conditions (temperature/humidity/wet bulb, ocean/water body temperature)
Chiller lift (or condenser water leaving temperature and chilled water leaving temperature)
Cooling Tower Fan VSD speeds
Chilled/Condensing water pump speeds or flow rates
Differential pressure across chiller condenser and evaporator

For a chilled water plant that includes a chiller and cooling tower, the following supplementary or alternative information may be received:
Chilled Water Supply/Return Temperatures
Condenser Water Supply/Return Temperatures
Chilled Water Flow Rates
Condenser Water Flow Rates
Cooling Tower energy consumption
Chilled/Condenser Water Pump energy consumption
Building occupancy
Equipment voltage, amps, frequency
Common chilled or condenser water supply and return temperatures.
Common chilled or condenser water flow rates

Historical telemetry data may be complemented by several pieces of system information (referred to as metadata). This metadata may include chiller nominal cooling capacity, minimum and maximum flow rates through the condenser and evaporator, pump and fan rated kW consumption. These points assist in modelling and verifying model accuracy, although are not essential to the process. System constraints or limitations can be provided as inputs here (constraints discussed further below).

The process then involves data identification, tagging, renaming and transformation using an automatic process of rule based manipulation 23. Calculations are performed on the data to compute secondary variables. This includes the computation of chiller lift and load using chilled/condenser water temps, flow rate for each of the one or more chillers in the plant. Chiller loading is calculated as a percent of chiller cooling capacity (kW) using, for example, the following equations:

Chiller Load=Chiller kWr/Chiller Capacity

or

Chiller Load=((Specific heat capacity of water)(chilled water flow rate)(chilled water loop temperature difference))/Chiller Capacity

For a water cooled (or ocean/water body cooled) chiller, the following equations may be used to determine chiller lift:

Chiller lift=(Condenser water leaving temperature−chilled water leaving temperature)

or

Chiller lift=Average(condenser water entering temp,condenser water leaving temp)−Average (chilled water entering temp,chiller water leaving temp)

For an air cooled chiller, the following equation may be used to determine chiller lift:

Chiller Lift=(Ambient Dry Bulb Temperature−chilled water leaving temperature)

A chiller's coefficient of performance (COP) may be determined using the following equation:

Chiller COP=Chiller kWr/Chiller kWe

Pump and fan energy consumption may be obtained directly from historical data or using affinity laws.

Referring again to FIG. 3, the process then involves an optional energy balance 7 of the chilled water plant system. The purpose of the energy balance is to compare parts of the system where performance is able to be determined using first principles, and comparing that calculated performance with the actual performance calculations described above. This allows the system to determine that the system is operating generally as expected, to confirm that the historical calculations are generally accurate, and to confirm the specifications of the plant match the data set provided. The energy balance can also be used to determine if plant specifications or metadata are missing, and can be used to fill in missing data if required (e.g. supplement the calculated historical information with data determined using first principles). The energy balance may also be used to determine specific metadata values (eg. pump power ratings, determined from full speed operating energy)

The energy balance involves computation of the heat transfer across the evaporator and condenser for each chiller and the wider chilled and condenser water loop(s).

The following equations may be used to determine evaporator energy transfer:

Evaporator energy transfer=(Chilled water flow rate)(Specific Heat Capacity of Fluid)(entering evaporator temperature−leaving evaporator temperature)

The following equations may be used to determine condenser energy transfer:

Condenser energy transfer=(condenser water flow rate)(Specific Heat Capacity of Fluid)(leaving condenser temperature−entering condenser temperature)

The heat rejection across the open or closed circuit cooling towers as a function of cooling tower energy input may also be determined.

By computing a rigorous energy balance on each piece of equipment the relevant flows of energy can be followed, and the system layout determined algorithmically, for example by analysing pump flows against expected chiller heat transfer to link specific pumps and chillers. The system layout can also be provided from the ontology of ingested data, especially where this includes a relational mapping between pieces of equipment (hierarchy).

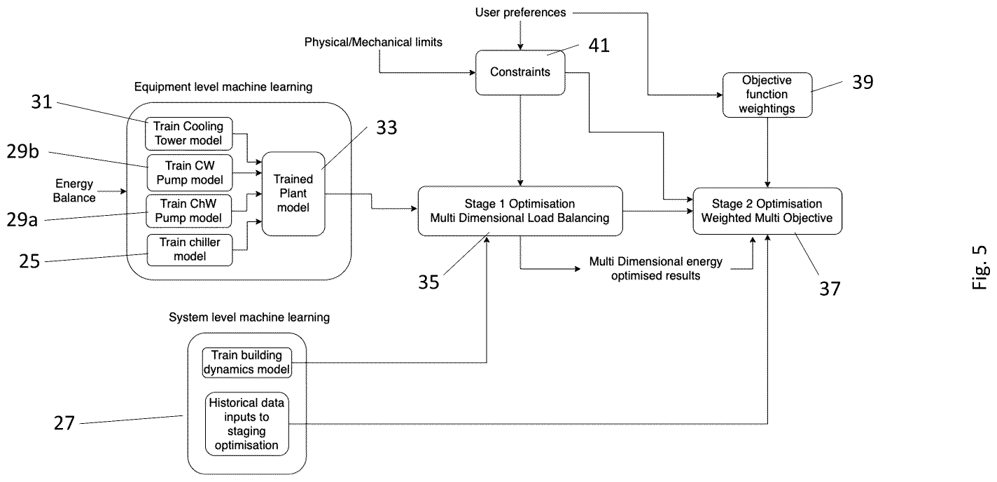

The optional energy balance process 7 is then followed by a set of equipment level modelling processes 9 and a system level modelling process 11. These modelling processes are then followed by two stage optimisation processes 13, 15. The foregoing processes will now be described further with reference to the flow diagram provided in FIG. 5.

The equipment level modelling step includes developing and training a chiller model 25 for the plant. In the detailed embodiment, this includes developing and training an ML based predictive mathematical model for each chiller in the chilled water plant. The predictive ML model is trained as a way of computing chiller COP as a function of lift and chiller loading. A typical model for chiller COP uses 2-dimensional polynomial regression, where COP is a function of chiller lift and load.

The equipment level modelling step also includes training a predictive ML model for building cooling load (field demand) using some or all of the following data: occupancy, day of week (DoW), time of day (ToD), outside ambient dry-bulb temperature (DBT), and relative humidity (RH), outside ambient wet bulb temperature (WBT), season(S). As such, field demand typically a function of some or all of DBT, RH, occupancy, ToD, DoW, WBT and S.

The equipment level modelling step also includes the development and training of a ML based predictive mathematical model to represent chilled water pump (ChW) and condenser water pump (CW) flow 29a, 29b as a function of energy consumption. Inputs may include pump variable frequency drive (VFD) speeds, chiller loading (CL), pump energy consumption (PE), flow rates, and pump rated power, head pressure (HP) or chiller differential pressure. As such, pump flow may be a function of PE, HP and CL.

One or more linear or quadratic regression models can be used to describe the relationship between chiller loading and pump speed or flow. Modelling of pump energy consumption involves the use of pump affinity laws (Pump power∝pump speed³).

The equipment level modelling step also includes the development and training of an ML based predictive mathematical model 31 to represent cooling tower efficiency as a function of cooling tower energy consumption. This enables prediction of optimal entering condenser water temperature (ECWT). Inputs may include condenser heat transfer across header (Q), cooling tower VFD speed (FS), cooling tower energy consumption, cooling tower leaving temperature (ECWT), cooling tower entering temperature (LCWT), and ambient wet bulb temperature (WBT) or ambient dry bulb temperature (DBT) (in the case of closed circuit cooling towers), and range. Approach temp (A) may determined as follows: ECWT−WBT. For a closed circuit cooling tower A=ECWT−DBT. As such, ECWT is a function of Q, FS, LCWT, and WBT or DBT. Fan speed is a function of Q and A, and can typically be defined in terms of an exponential, cubic, quadratic, or linear regression model. Fan affinity laws are used to model CT energy consumption (Fan power∝FS³). In the case of ocean/brine cooled systems, ECWT is equal to ambient ocean temperature.

The system level modelling process is performed once each of the equipment level modelling steps have been completed. This process involves refining a combined chilled water plant simulation from the smaller subsystem (equipment level) models. The simulation provides a combined chilled water plant model 33. The model 33 provides a reliable way to predict energy consumption of the entire chilled water plant for any given mode of operation or plant state, considering the various interactions between different pieces of equipment.

The various interactions and relationships between plant equipment and energy consumption are combined into a single cost function (system energy consumption). Independent variables are either optimised for or pre-defined, then each of the dependent variables is computed in the required order and hierarchy to determine the cost for a given set of input parameters. System energy consumption is the sum of CE, PE, CTE, where CE refers to the sum of chiller energy consumption, PE refers to the sum of pump energy consumption, and CTE refers to the sum of cooling tower fan energy consumption.

This combined chilled water plant model 33 uses the energy balance and equipment hierarchy developed above to effectively map equipment relationships. Constraints on the operation of various pieces of equipment are discussed below, and may be provided as inputs from the user.

A typical iteration of the system cost function will involve defining the building cooling load, and ambient conditions, as well as equipment specifications (eg. power ratings, chiller capacity, etc). Optimisation modulates or selects chiller loading proportions and fan speeds.

These optimised variables are fed into regression models (equations defining relationships between plant equipment) sequentially. For example: chiller loading is used to determine the required chilled and condenser water pump speed/flow, which is then used to calculate the associated pump energy consumption. This is then used to calculate the heat rejection on the condenser side, and ensure that energy balance is maintained. Fan speed, condenser heat rejection and ambient conditions are inputs used to determine ECWT and condenser Range. Entering and leaving temperatures may be verified with energy balance and chiller lift calculated.

Chiller lift and load are inputs to the chiller COP model, used to calculate chiller energy consumption. All dependent variables are recorded and confirmed within constraints/boundaries. Invalid solutions are rejected.

In the disclosed embodiment, machine learning is used to perform the modelling processes including to develop and train predictive ML models for the chillers, building cooling load (field demand), chilled and condenser water pump flow and cooling tower efficiency. In other example embodiments, alternative mathematical and computational techniques may be used to perform the modelling processes, in lieu of machine learning. For example, the use of physics-based equipment models alongside equipment metadata, or convergence-based error minimisation techniques to determine equipment properties.

The process then involves a ‘Two-Stage Optimisation’ for all system conditions.

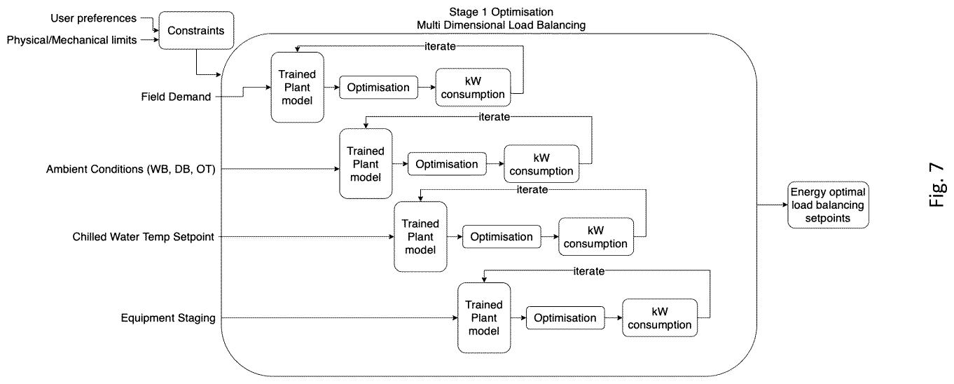

Optimisation is performed in two distinct processes. The first system optimisation process (referred to here as “Load Balancing optimisation” 35) involves the use of one or more constrained global optimisation algorithms (eg. particle swarm optimisation or shuffled complex evolution) to produce an optimised control strategy for the chiller of the plant. FIG. 7 provides a flow diagram of the stage 1 optimisation process. The algorithm used can be dependent on the system size and characteristics. These algorithms use the simulation of the system to predict the energy consumption of the system at incremental cooling demand points up to system capacity, while varying individual equipment parameters. A complete combinatorial set of outputs is generated, by repeatedly constraining sets of chillers to be either on or off (eg. defining a given ‘stage’ of operation). In this way, the system produces an optimal strategy for any given combination of available chillers, which also facilitates the variation in the metrics to be optimised in stage 2 (described further below).

This model is constrained to provide the same chilled water flow and leaving temperature as the system before optimisation. As such there will be no impact on service delivery.

The objective function of this optimisation is the total electric power consumed by the entire chilled water plant (chillers, condenser and chilled water pumps, cooling tower fans). This optimisation is performed loop wise, at a plurality of possible field demands (kWr), ambient conditions, chilled water leaving temperatures, and equipment stagings, in order to develop a complete set of optimised results. Optimised outputs of the Load Balancing optimisation are chiller staging setpoints, chiller load balancing proportions, condenser water entering temperature (ECWT), and condenser water pump speeds at every cooling load and for all combinations of operational chillers. The Load Balancing optimisation is constrained within the physical limits of the system, such that all results produced are valid, and physically feasible. The constraints which can be placed on the load balancing algorithm include the following:
Minimum/maximum lift for a given chiller(s) (Deg. C).
Minimum/maximum entering and/or leaving condenser water temperature for a given chiller(s) (Deg. C.)
Minimum/maximum entering and/or leaving evaporator water temperature for a given chiller(s) (Deg. C.)
Minimum/maximum flow rate through evaporator for a given chiller(s) (L/s)
Minimum/maximum flow rate through condenser for a given chiller(s) (L/s)
Turn down ratio for a given chiller(s) (%).
Turn down ratio for a given cooling tower(s) (%)
Maximum amps for a given chiller(s) as a proportion of full load amps (%)
Maximum stage up demand setpoint as a proportion of stage capacity (%)

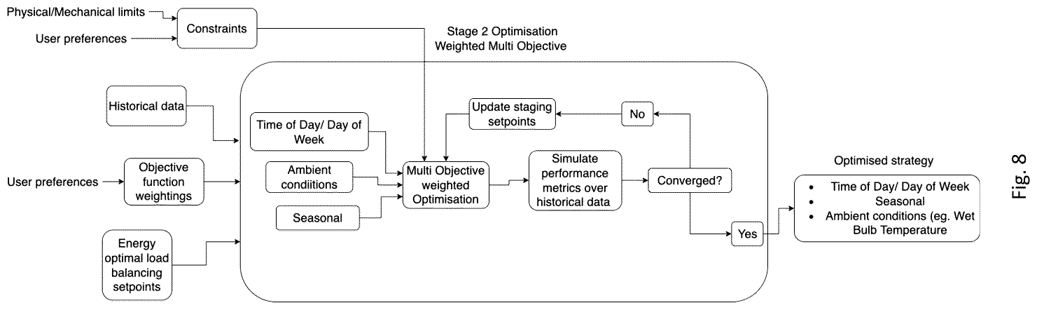

The second stage of optimisation uses the results from stage 1 (Load Balancing) as an input, alongside historical telemetry data to produce a chilled plant strategy that comprises optimised control parameters (setpoints) for the chilled water plant as a whole. Stage 2 is referred to as “Staging Optimisation” 37. FIG. 8 provides a flow diagram of the stage 2 optimisation process. In stage 2, the cost function is a function of several variables (seven in the detailed embodiment), all expressed as ratios of simulated performance against historical performance in a given data period:
Energy consumption (kWh) (energy (kWh) consumed over the simulation period)
Peak demand (PD) (peak demand (kVA) of central plant)
Chiller loading (CL) (proportion of time each chiller is operating in a loading range that is favourable to performance and longevity)
Chiller start stops (CSS) (aggregated number of start/stop cycles)
Chiller runtime (CR) (runtime hours per chiller)
Chiller short cycles (CSC) (aggregated number of start/stop cycles within a 30 minute (adjustable) period)
Runtime equalisation (RE) (runtime balance between chillers)

These variables, which contribute to the cost function, may be weighted per user requirements (including maintenance considerations, environmental targets, energy cost etc.) in order to influence the optimisation output 39. The cost function may be as follows (z, y, x, w, v, u, and t are the weightings on the respective cost function inputs):

$$Cost = z \times kWh + y \times PD + x \times CL + w \times CSS + v \times CR + u \times CSC + t \times RE$$

Staging optimisation uses the weighted cost function as a method of reducing the total cost of operation of the chilled water plant, while adhering to user constraints and preferences regarding operation. Staging optimisation varies the chiller stage up and down demand setpoints while calculating the various metrics above across a historical data period defined by the user (typically seasonal or annual). Field demand (kWr) and historical loadings of all chillers, as well as energy consumption of the chilled water plant are used to form a baseline.

The optimisation algorithm may then simulate the staging as a logical controller in a BMS would typically operate. A minimum of 15 minutes (adjustable) spent above or below a staging setpoint will trigger a change in stage, and different chiller operation, including changes in load balancing and operational chillers. This optimisation uses particle swarm optimisation, or a similar algorithm (e.g. shuffled complex evolution) to repeatedly vary the inputs (chiller stage up/down demand setpoints), and measure the weighted cost function. The output of the staging optimisation process is a set of metrics (the statistics or relative change in value associated with each of the above cost inputs), as well as the optimised stage up and down demand setpoints which minimise these costs. This allows a selection of the load balancing optimisation results to be chosen from these stage up/down demand setpoints, producing a final set of outputs.

The staging optimisation cost function allows for simultaneous simulation of the results against historical data for verification of energy, peak demand, and operational savings. Results from the staging optimiser are able to be interrogated if desired, before integration into the user's BMS system. The outputs of this optimisation may be:
Chiller stage up/down demand setpoints (chiller on/off operation);
Chiller load balancing proportions (chiller loading typically as a function of kWr demand for a given stage);
Condenser water leaving temp setpoints (typically represented as a function of kWr demand plus a constant for a given stage); and/or
Condenser water flow setpoints (represented as a function of chiller load for a given stage)

Constraints 41 and weighting can be placed on the staging optimisation algorithm by, for example:
Minimising and/or maximising runtime ratio of a given chiller(s);
Minimising and/or maximising start/stop count ratio of a given chiller(s);
Minimising and/or maximising short cycle ratio of a given chiller(s);
Minimising and/or maximising change in chiller loading ratio of a given chiller(s); and/or
Weightings for certain chiller(s) as input to runtime equalisation metric.

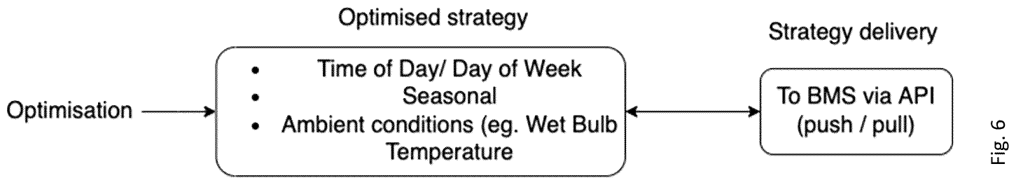

The method will now be described with reference to FIG. 6, which provides a flow diagram of the delivery of the optimised chilled plant strategy to a chilled water plant controller. In the detailed embodiment, optimised control setpoints that form part of the strategy are made available via an API (push or pull) to a BMS of the plant). The optimised control setpoints are able to be incorporated into existing BMS logic. These optimised control setpoints are provided in a standardised form, incorporating a table of chiller on/off setpoints, as well as load balancing proportions, ECWT, and condenser water pump flow setpoints for all field demands for a given stage. The model is periodically updated (as required, typically seasonally or annually), and updated outputs written to BMS as required. In an alternative embodiment, a user may translate the system outputs into the BMS.

Example results/setpoints for writing to the BMS controller include:

| Stage | Chiller 1 Load | Chiller 2 Load | Chiller 3 Load |
|---|---|---|---|
| 1 | Enabled | Disabled | Disabled |
| 2 | Enabled | Enabled | Disabled |
| 3 | Enabled | Enabled | Enabled |

| | | | | | Condenser | Condenser | Condenser |
|---|---|---|---|---|---|---|---|
| Cooling | | Chiller | Chiller | Chiller | water entering | water pump | water pump |
| demand | | 1 | 2 | 3 | temperature | 1 Flow Rate | 2 Flow Rate |
| (kWr) | Stage | Load | Load | Load | (ECWT) ° C. | (L/s) | (L/s) |
| 100 | 1 | 0.15 | 0 | 0 | 24 | 45 | 0 |
| . . . | . . . | . . . | . . . | . . . | . . . | . . . | . . . |
| 750 | 2 | 0.8 | 0.4 | 0 | 27 | 38 | 38 |
| . . . | . . . | . . . | . . . | . . . | . . . | . . . | . . . |
| 1350 | 3 | 0.7 | 0.6 | 0.55 | 31 | 55 | 55 |

The system and method herein disclosed are tied inextricably to, and provide a significant improvement to, chilled water plant system control technology. In particular, the disclosed solution addresses the technical problem of optimising the performance of embedded controllers that operate chilled water plants in an effective manner. Prior optimisation methods rely on rules of thumb and involve ad hoc incremental modifications to system variables for individual plant equipment in a siloed manner. Such methods result in poor efficiency improvements and do not account for the interdependencies of chilled water plant equipment, and the associated operational synergies and antagonisms of such equipment, when the equipment is operating together. The technical steps employed by the disclosed solution advantageously involve a set of distinct, but interrelated, bespoke optimisation techniques that are performed in parallel and series to generate equipment-level and plant-level (global) predictive models. These models are derived from empirical performance information, in turn based on historical telemetry data for the plant equipment, and used to determine a set of optimised plant operating points. These operating points drive the execution of an embedded controller of the chilled water plant and cause the controller to execute in a manner that takes into account the operational interdependencies of the individual plant equipment.

More particularly, the disclosed solution includes a modelling stage which involves the production of a set of predictive models for one or more chillers and pumps of the plant and for a field load demand of the plant. These models are developed concurrently using an algorithmic optimisation process, such as machine learning, based on historical performance information, wherein the performance information is derived from extracted operating data for the respective plant equipment. The chiller and pump models are subsequently used to determine a holistic operating model of the chilled water plant. The solution then employs a two-phase global optimisation process which involves performing simulations of the chilled water plant to obtain a set of optimised control parameters. The first phase involves performing plant simulations, using the holistic operating model, to derive an initial set of optimised control parameters. The second phase involves the production of a set of refined control parameters based on (i) energy consumption data derived from the initial optimised control parameters, (ii) an optimised chiller control strategy derived from the energy consumption data and (iii) the field load demand model developed during the modelling stage. The refined control parameters are provided to an embedded controller of the chilled water plant to drive its execution. The final set of control parameters are, therefore, derived using a sequence of models and simulations that are based on individual equipment and the chilled water plant at a holistic/inter-operational level. The parameters advantageously cause the controller to operate the chilled water plant in an optimal manner that takes into account the historical performance of the plant, including the associated operational interdependencies of the individual equipment comprised in the plant.

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

1. A system for controlling chilled water plant, the chilled water plant comprising one or more chillers, one or more water pumps, and a controller, the system comprising one or more processors configured to:
receive first information, the first information comprising historical data for a plurality of system variables for the chilled water plant;
determine historical performance information for the chilled water plant using the received first information;
prepare performance models using the received first information and historical performance information, the performance models comprising:
at least one chiller predictive model for the one or more chillers; and
at least one pump predictive model for the one or more water pumps;
prepare a field load predictive model for a field load demand;
prepare a chilled water plant model that is dependent on the at least one chiller predictive model and the least one pump predictive model;
simulate operation of the chilled water plant for a plurality of plant operating conditions using the chilled water plant model and determining first optimised control parameters for the chilled water plant;
determine an energy consumption of the chilled water plant using the first optimised control parameters for a plurality of load demands to determine an optimised control strategy for the one or more chillers;
determine second optimised control parameters for the chilled water plant using the energy consumption of the chilled water plant, the optimised control strategy for the one or more chillers and the field load predictive model; and
output the second optimised control parameters for the chilled water plant to the controller of the chilled water plant to optimise control of the chilled water plant.

2. A system for controlling chilled water plant according to claim 1, wherein the chilled water plant comprises one or more cooling towers, and wherein the performance models further comprises at least one cooling tower predictive model for the one or more cooling towers, and wherein preparing the chilled water plant model is dependent on the at least one cooling tower predictive model.

3. A system for controlling chilled water plant according to claim 1 wherein the one or more processors are configured to:
verify the historical performance information by preparing an energy balance information for the chilled water plant using at least the first information, the energy balance information comprising a chiller energy balance for the one or more chillers, and a cooling tower energy balance for the one or more cooling towers;
wherein the first information comprises a plurality of timestamped chiller cooling loads, chiller energy consumptions, ambient air conditions, chiller lifts or condenser water leaving temperatures and chilled water leaving temperatures, cooling tower fan variable speed drive speeds, chilled and/or condensing water p speeds of flow rates, and differential pressures across a chiller condenser and a chill evaporator; and
wherein the first information comprises supplementary metadata, the supplementary metadata comprising a chiller nominal cooling capacity, a minimum and a maximum flow rate through a condenser and an evaporator that forms part of the chilled water plant, rated energy consumption for fans and pumps that form part of the chilled water plant.

4. (canceled)

5. (canceled)

6. A system for controlling chilled water plant according to claim 1 wherein the one or more processors are configured to:
transform the first information to determine second information, the second information comprising chiller lift and chiller load, wherein the determined second information then forms part of the first information that is used to prepare the performance models.

7. A system for controlling chilled water plant according to claim 1 wherein preparation of the at least one chiller predictive model comprises developing and training a machine learning based predictive mathematical model for the one or more chillers.

8. A system for controlling chilled water plant according to claim 1 wherein preparation of the field load predictive model comprises developing and training a machine learning based predictive mathematical model for field load.

9. A system for controlling chilled water plant according to claim 1 wherein preparation of the at least one pump predictive model comprises developing and training a machine learning based predictive mathematical model for the for the one or more water pumps.

10. A system for controlling chilled water plant according to claim 2 wherein preparation of the at least one cooling tower predictive model comprises developing and training a machine learning based predictive mathematical model for the one or more cooling towers.

11. A system for controlling chilled water plant according to claim 2 wherein determining the optimised control strategy for the one or more chillers comprises;
determining a total electric power consumed by the chilled water plant at a plurality of field demands to determine the optimised control strategy, the optimised control strategy comprising chiller staging setpoints, chiller load balancing proportions, condenser water entering temperature, and condenser water pump speeds at the plurality of field demands;
wherein determining the optimised control strategy for the one or more chillers comprises constraining the determination of the optimised control strategy by including a minimum and a maximum lift for the one or more chillers, a minimum and a maximum entering and/or leaving condenser water temperature for the one or more chillers, a minimum and a maximum entering and/or leaving evaporator water temperature for the one or more chillers, a minimum and a maximum flow rate throw me or more evaporators of the one or more chillers, a minimum and a maximum flow rate through one or more condensers of the one or more chillers, a turn down ratio the one or more chillers, a turn down ratio for the one or more cooling towers, a maximum amps for the one or more chillers, and a maximum stage up demand setpoint for the one or more ages of possible chiller operation.

12. (canceled)

13. A system for controlling chilled water plant according to claim 1; wherein determining the second optimised control parameters for the chilled water plant comprises preparing a cost function of a plurality of system variables, the plurality of system variables comprising an energy consumption, a peak demand, a chiller loading, an aggregated number of chiller start/stop cycles, a chiller runtime, an aggregated number of chiller short cycles within a predetermined period, and a weighted runtime balance between the one or more chillers; and
wherein preparing the cost function comprises applying a weighting for each one of the plurality of system variables.

14. (canceled)

15. A system for controlling chilled water plant according to claim 1 wherein the second optimised control parameters comprise chiller stage up/down demand setpoints, chiller load balancing proportions, condenser water leaving temp setpoints; and/or condenser water flow setpoints.

16. A method for optimising the control of chilled water plant, the chilled water plant comprising one or more chillers, one or more water pumps, and a controller, the method comprising:
receiving at one or more processors a first information, the first information comprising historical data for a plurality of system variables for the chilled water plant;
determining historical performance information for the chilled water plant using the one or more processers, determination of the historical performance information for the chilled water plant being dependent on the received first information;
preparing performance models using the one or more processers, preparation of the performance models being dependent on the received first information and historical performance information, the performance models comprising:
at least one chiller predictive model for the one or more chillers, and
at least one pump predictive model for the one or more water pumps;
preparing a field load predictive model for a field load demand using the one or more processers;
preparing a chilled water plant model using the one or more processers, preparation of the chilled water plant model being dependent on the at least one chiller predictive model, and the least one pump predictive model;
simulating operation of the chilled water plant for a plurality of plant operating conditions using the one or more processers to determine first optimised control parameters for the chilled water plant, simulation of the operation of the chilled water plant being dependent on the chilled water plant model;
determining an energy consumption of the chilled water plant using the one or more processers to determine an optimised control strategy for the one or more chillers, determining the energy consumption of the chilled water plant being dependent on the first optimised control parameters for a plurality of load demands;
determining second optimised control parameters for the chilled water plant using the one or more processors, determination of the second optimised control parameters being dependent on the energy consumption of the chilled water plant, the optimised control strategy for the one or more chillers and the field load predictive model; and
outputting the second optimised control parameters for the chilled water plant to the controller of the chilled water plant to optimise control of the chilled water plant.

17. A method according to claim 12, wherein the chilled water plant comprises one or more cooling towers, and wherein the performance models further comprises at least one cooling tower predictive model for the one or more cooling towers, and wherein preparing the chilled water plant model is dependent on the at least one cooling tower predictive model.

18. A method according to claim 12 comprising; verifying the historical performance information by preparing an energy balance information for the chilled water plant using the one or more processors, the preparation of the energy balance information being dependent on at least the first information, the energy balance information comprising a chiller energy balance for the one or more chillers, and a cooling tower energy balance for the one or more cooling towers:
wherein the first information comprises a plurality of timestamped chiller cooling loads, chiller energy consumptions, ambient air conditions, chiller lifts or condenser water leaving temperatures and chilled water leaving temperatures, cooling tower fan variable speed drive speeds, chilled and/or condensing water speeds or flow rates, and differential pressures across a chiller condenser and a chiller evaporator; and
wherein the first information comprises supplementary metadata, the supplementary metadata comprising a chiller nominal cooling capacity, a minimum and a maximum flow rate through a condenser and an evaporator that forms part of the chilled water plant, rated energy consumption for fans and pumps that form part of the chilled water plant.

19. (canceled)

20. (canceled)

21. A method according to claim 12, comprising transforming the first information using the one or more processors to determine second information, the second information comprising chiller lift and chiller load, wherein the determined second information then forms part of the first information that is used to prepare the performance models.

22. A method according to claim 13, wherein:
preparation of the at least one chiller predictive model comprises developing and training a machine learning based predictive mathematical model for the one or more chillers using the more or more processors;
preparation of the field load predictive model comprises developing and training a machine learning based predictive mathematical model for field load using the more or more processors;
preparation of the at least one pump predictive model comprises developing and training a machine learning based predictive mathematical model for the one or more water pumps; and
preparation of the at least one cooling tower predictive model comprises developing and training a machine learning based predictive mathematical model for the one or more cooling towers.

23. A method according to claim 13, wherein determining the optimised control strategy for the one or more chillers comprises determining a total electric power consumed by the chilled water plant at a plurality of field demands to determine the optimised control strategy, the optimised control strategy comprising chiller staging setpoints, chiller load balancing proportions, condenser water entering temperature, and condenser water pump speeds at the plurality of field demands; and
wherein determining the optimised control strategy for the one or more chillers comprises constraining the determination of the optimised control strategy by including a minimum and a maximum life for the one or more chillers, a minimum and a maximum entering and/or leaving condenser water temperature for the one or more chillers, a minimum and a maximum entering and/or leaving evaporator water temperature for the one or more chillers, a minimum and a maximum flow rate through one or more evaporators of the one or more chillers, a minimum and a maximum flow rate through one or more condensers of the one or more chillers, a turn down ratio the one or more chillers, a turn down ratio for the one or more cooling towers, a maximum amps for the one or more chillers, and a maximum demand setpoint for the one or more stages of chiller operation.

24. (canceled)

25. A method according to claim 12, wherein determining the second optimised control parameters for the chilled water plant comprises preparing a cost function of a plurality of system variables, the plurality of system variables comprising an energy consumption, a peak demand, a chiller loading, an aggregated number of chiller start/stop cycles, a chiller runtime, an aggregated number of chiller short cycles within a predetermined period, and a weighted runtime balance between the one or more chillers.

26. A method according to claim 12, wherein preparing the cost function comprises applying a weighting for each one of the plurality of system variables.

27. A method according to claim 12, wherein the second optimised control parameters comprise chiller stage up/down demand setpoints, chiller load balancing proportions, condenser water leaving temp setpoints; and/or condenser water flow setpoints.
